(19) United States
(12) Patent Application Publication
(10) Pub. No.: US 2026/0346724 A1
(43) Pub. Date: Nov. 5, 2026

(54) BATTERY MANAGEMENT UNIT, BATTERY, AND ELECTRIC BICYCLE

(71) Applicant: Porsche eBike Performance GmbH, Ottobrunn (DE)

(72) Inventors: Ivan Stepanic, Velika Gorica (HR); Anton Kanyshev, Zagreb (HR)

(21) Appl. No.: 19/658,378

(22) Filed: Apr. 24, 2026

(30) Foreign Application Priority Data
Apr. 30, 2025 (DE) 10 2025 116 759.1

(51) Int. Cl. B60L 3/00; B60L 1/00; B62M 6/90; H01M 10/42; H01M 50/574; H02J 7/62; H02J 7/64

(52) U.S. Cl. CPC B60L 3/0046; B60L 1/00; B62M 6/90; H01M 10/425; H01M 50/574; H02J 7/62; H02J 7/64; B60L 2200/12; H01M 2010/4271; H01M 2220/20

(57) ABSTRACT

A battery management unit includes a contact point for contacting the battery management unit to a battery cell and a connection point for connecting an external device. The external device can then be supplied with electrical energy from the battery cell via the connection point. Furthermore, the battery management unit includes a protection circuit for protection against overcurrent and/or overvoltage. The protection circuit is configured to cause an interruption of an electrical connection between the contact point and the connection point in the event of overcurrent and/or overvoltage during operation. The protection circuit is integrated into a chip.

### CROSS-REFERENCE TO RELATED APPLICATIONS

This application claims priority of German patent application no. 10 2025 116 759.1, filed April 30, 2025, the entire content of which is incorporated herein by reference.

### TECHNICAL FIELD

A battery management unit for an electric bicycle is described. In addition, a battery for an electric bicycle and an electric bicycle are described.

### BACKGROUND

In recent years, enthusiasm for electric bicycles (especially so-called “pedelecs”) has been growing, despite their relatively high weight and price compared to conventional bicycles. With electric bicycles, ensuring safe operation is a priority.

### SUMMARY

It is an object of the disclosure to provide a battery management unit for an electric bicycle that contributes to the safe operation of the electric bicycle and has a compact configuration. It is a further object of the disclosure to provide a battery with such a battery management unit and an electric bicycle with such a battery management unit.

The aforementioned objects are, for example, achieved by various embodiments of the disclosure.

First, the battery management unit is described. The battery management unit is often also referred to as a battery management system, or BMS for short.

In at least one embodiment, the battery management unit includes a contact point for contacting the battery management unit to a battery cell and a connection point for connecting an external device. The external device can then be supplied with electrical energy from the battery cell via the connection point. Furthermore, the battery management unit includes a protection circuit for protection against overcurrent and/or overvoltage. The protection circuit is configured to cause an interruption of an electrical connection between the contact point and the connection point in the event of overcurrent and/or overvoltage during operation. The protection circuit is integrated into a chip.

The present disclosure is based, among other things, on the recognition that the use of multiple individual components to implement a protection circuit is costly and requires a significant amount of space on the printed circuit board. The use of a chip in which the protection circuit is integrated reduces costs, saves space, and makes the protection circuit easy to configure.

In one embodiment, the battery management unit includes a printed circuit board, in particular a PCB. The contact point, the connection point, and the protection circuit are, for example, arranged on the printed circuit board and electrically coupled to one another via it. For example, the contact point and the connection point are arranged on different sides of the printed circuit board. The contact point and the connection point are, in particular, connected to one or more electronic switches in order to interrupt or establish an electrical connection between the contact point and the connection point by opening or closing the switch.

The contact point is configured for an electrical connection to one or more battery cells. The contact point is formed, in particular, from metal. For example, the contact point is a connector, such as an FPC connector or a connector with a spring mechanism. The contact point is, for example, soldered or printed onto the printed circuit board. In particular, the battery management unit has two contact points for contacting both poles of the battery cell(s).

The connection point is, for example, a connector, such as a female connector. The connector may include a connector housing, for example made of plastic. The connector housing protrudes, for example, from the printed circuit board. An external device can be electrically connected to the connection point and supplied with electrical power from the battery cell. The external device includes, for example, the electric motor of the electric bicycle. Alternatively or additionally, other electrical loads, such as small electrical loads, can be connected to the connection point. For example, multiple electrical components of the electric bicycle can be supplied with electrical energy simultaneously via the connection point.

The connection point includes, for example, several contacts for electrical and mechanical connection to corresponding contacts or pins of a corresponding connection point, such as a male connector. For example, the connection point includes two contacts for supplying the external device with the battery’s main voltage. The main voltage is, for example, 48 V. Furthermore, the connection point may include two auxiliary contacts for supplying additional electrical components with a voltage lower than the main voltage, for example 12 V. Alternatively or additionally, the connection point may include contacts for a CAN bus.

The protection circuit is configured to protect against overcurrent and/or overvoltage during operation. During operation, the battery cell is discharged via the battery management unit, for example. Alternatively or additionally, the battery cell can be charged via the battery management unit during operation. This means that the protection circuit is specifically configured to protect against overcurrent and/or overvoltage during the discharging and/or charging of the battery cell.

The protection circuit is configured to cause the battery management unit to interrupt an electrical connection between the contact point and the connection point in the event of an overcurrent and/or overvoltage. In particular, the protection circuit is configured to detect such an overcurrent or overvoltage and then generate a corresponding control signal for the battery management unit.

The protection circuit includes, for example, one or more inputs for electrical input signals representative of current and/or voltage during operation, and one or more outputs for electrical control signals. The protection circuit is specifically configured to determine, based on the input signals, whether an overcurrent and/or overvoltage is present and, in this case, to generate a control signal for one or more electrical components of the battery management unit, in particular for one or more electronic switches. The control signal is then output via one of the outputs during operation and causes an interruption of the electrical connection between the contact point and the connection point, in particular to interrupt the charging or discharging process.

The entire protection circuit is integrated into a single chip. The chip has, for example, dimensions of at most 10x10 mm² or at most 7x7 mm².

According to at least one embodiment, the chip is an FPGA (field-programmable gate array).

According to at least one embodiment, the protection circuit is a configurable mixed-signal matrix. In other words, the chip is a mixed-signal IC. This includes analog and digital components. A mixed-signal matrix is an integrated circuit structure that combines both analog and digital signal paths in a configurable grid arrangement. It enables the flexible interconnection and processing of analog and digital signals within a semiconductor device. The matrix includes programmable nodes that can perform various signal processing functions— —such as amplification, conversion (AD/DA), switching, or logical operations. Thanks to its reconfigurable architecture, the mixed-signal matrix can be adapted to different applications and enables the implementation of complex signal processing systems on a single platform.

According to at least one embodiment, the protection circuit provides protection against short circuits. In particular, the protection circuit is configured to determine, based on an input signal, whether a short circuit occurs during the charging or discharging of the battery cell and, if a short circuit is detected, to generate a corresponding control signal.

According to at least one embodiment, the protection circuit provides protection against overcurrent during discharge of the battery cell. In particular, the protection circuit is configured to determine, based on an input signal, whether a predetermined maximum discharge current is exceeded during discharge of the battery cell and, if exceeded, to generate a corresponding control signal.

According to at least one embodiment, the protection circuit provides protection against overcurrent during charging of the battery cell. In particular, the protection circuit is configured to determine, based on an input signal, whether a predetermined maximum charging current is exceeded during charging of the battery cell and, if exceeded, to generate a corresponding control signal.

According to at least one embodiment, the protection circuit provides protection against overvoltage during charging of the battery cell. In particular, the protection circuit is configured to determine, based on an input signal, whether a predetermined maximum charging voltage is exceeded during charging of the battery cell and to generate a corresponding control signal if it is exceeded.

According tat least one embodiment, the battery management unit includes an electronic switch for interrupting the electrical connection between the connection point and the contact point. In particular, the connection point can thus be electrically connected to the contact point via this electronic switch, such that opening or closing the switch interrupts or allows a current flow between the contact point and the connection point. The battery management unit may include multiple electronic switches. For example, the connection point and the contact point can be electrically connected to each other via each of these electronic switches.

According to at least one embodiment, this battery management unit includes multiple electronic switches, for example, at least one electronic switch for interrupting the discharge of the battery cell and at least one electronic switch for interrupting the charging of the battery cell. All features disclosed herein and hereinafter for an electronic switch are also disclosed for each additional electronic switch.

According to at least one embodiment, the protection circuit includes an input for an input signal that is representative of a discharge current during the discharge of the battery cell.

According to at least one embodiment, the protection circuit includes an output for outputting a control signal to the electronic switch. The control signal is then specifically configured to open or close the electronic switch.

According to at least one embodiment, the output is electrically connected to the electronic switch so that the switch can receive the control signal. For example, the output is connected to the electronic switch via a trace on the printed circuit board.

According to at least one embodiment, the protection circuit is configured to compare the input signal with a threshold value and to generate a control signal based on the comparison. The threshold value is, in particular, representative of a maximum permissible discharge current. The threshold value is a predetermined or preset value.

According to at least one embodiment, the protection circuit is configured such that the control signal is generated with a delay following the comparison, for example, delayed by a few milliseconds, such as between 2 ms and 10 ms inclusive. This allows the protection circuit to be given greater stability because, for example, short outliers are suppressed. If, for example, the input signal or the discharge current falls below the threshold value again within the delay time, no control signal is generated to interrupt the electrical connection.

According to at least one embodiment, the electronic switch is a MOSFET.

According to at least one embodiment, the protection circuit has a further input for a further input signal. The further input signal is representative of a short-circuit current during discharge of the battery cell. Alternatively, the additional input signal is representative of a charging current during charging of the battery cell. Alternatively, the additional input signal is representative of a voltage of the battery cell.

According to at least one embodiment, the protection circuit is configured to compare the additional input signal with an additional threshold value and to generate a control signal based on the comparison. This control signal is then output via the same output as mentioned above in connection with the discharge current, or via a different output.

Even for the additional input signal, particularly if it is representative of the charging current or voltage, the corresponding control signal may be generated with a delay.

According to at least one embodiment, the protection circuit has four inputs, wherein a first input is provided for a first input signal, and the first input signal is representative of a discharge current during the discharge of the battery cell. A second input is provided for a second input signal that is representative of a short-circuit current during the discharge of the battery cell. A third input is provided for a third input signal, which is representative of the charging current during charging of the battery cell. A fourth input is provided for a fourth input signal, which is representative of a voltage of the battery cell.

According to at least one embodiment, the protection circuit is configured to compare each of the four input signals with a corresponding threshold value and to generate a control signal based on this comparison.

Next, the battery is described. The battery is a battery for an electric bicycle. Specifically, the battery is the main battery of the electric bicycle, that is, the battery for powering the electric motor of the electric bicycle, which is intended for propelling the electric bicycle.

In at least one embodiment, the battery includes a battery cell, a housing, and the battery management unit according to one of the embodiments described herein. The battery management unit is electrically connected to the battery cell. The battery cell is housed within the housing. At least a portion of the battery management unit or the entire battery management unit may also be housed within the housing. The connection point is accessible from outside the housing.

Since the battery includes the battery management unit described herein, all features disclosed for the battery management unit are also disclosed for the battery, and vice versa.

The battery may include a plurality of battery cells, all of which are arranged within the housing. The battery cells are, for example, connected in parallel and/or in series with one another. In particular, all battery cells are electrically connected to the battery management unit. The electrical connection between the battery management unit and the battery cell or cells is established via the contact point.

The housing may include plastic and/or metal. The battery cells are, for example, completely enclosed by the housing, such as being sealed within the housing in a watertight manner. The battery management unit is also arranged within the housing; however, the connection point is accessible from outside the housing, for example, to insert a connector into the connection point.

The housing may be elongated in shape. The battery management unit is, for example, arranged in the region of one longitudinal end of the housing. The connection point is then accessible at this longitudinal end of the housing.

Next, the electric bicycle is described. The electric bicycle is, in particular, a pedelec.

In at least one embodiment, the electric bicycle includes a battery according to one of the embodiments described herein. Furthermore, the electric bicycle includes a drive device with an electric motor for propelling the electric bicycle. The drive device is coupled to the connection point to supply the drive device with electrical energy from the battery.

Since the electric bicycle includes the battery described herein, all features disclosed in connection with the battery are also disclosed for the electric bicycle, and vice versa.

The electric bicycle is, in particular, a mid-drive electric bicycle. This means that the drive device is located in the central area of the electric bicycle, for example in the area of the bottom bracket. The battery is, for example, located within the frame of the electric bicycle, specifically in the down tube of the electric bicycle. Similarly, the drive device may be located within the frame, for example in the down tube of the electric bicycle.

The drive device is coupled to the battery, for example, via a plug inserted into the connection point. The plug is electrically connected to the drive device via a cable, for example. One or more additional cables may extend from the plug to one or more additional electrical components in order to supply these components with electrical power from the battery.

The battery management unit, battery, and electric bicycle described herein are explained in more detail below with reference to the drawings and based on embodiments. Identical reference numerals denote identical, similar, or functionally equivalent elements in the FIGS. Insofar as elements or components in the various FIGS. have the same function, their description is not repeated for each of the following FIGS. For the sake of clarity, elements may not be provided with corresponding reference numerals in all FIGS.

### BRIEF DESCRIPTION OF DRAWINGS

The invention will now be described with reference to the drawings wherein:

FIG. 1 shows an embodiment of the electric bicycle;

FIGS. 2 and 3 show embodiments of the battery and the battery management unit in various views; and,

FIG. 4 shows an embodiment of the protection circuit.

### DETAILED DESCRIPTION

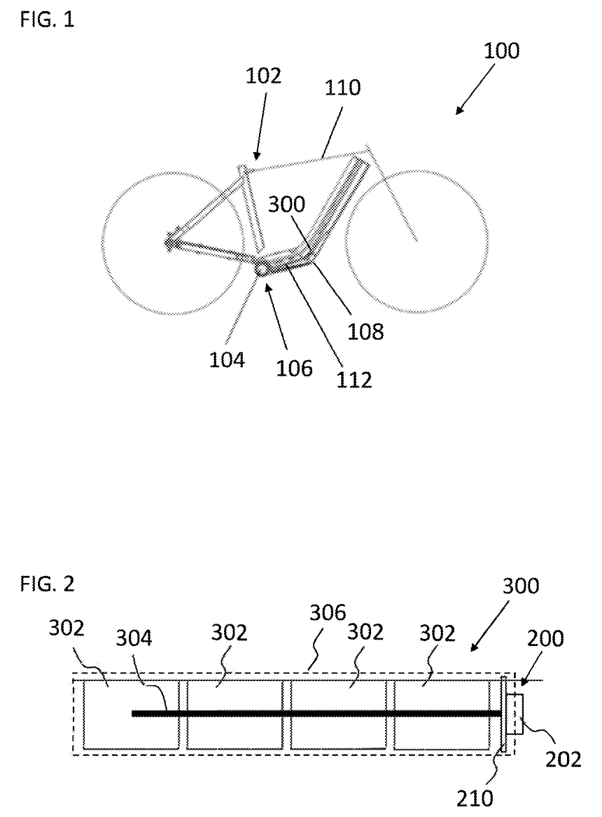

FIG. 1 schematically shows an electric bicycle 100 with a bicycle frame 102, which includes, among other things, a lower frame section 108 forming a down tube and an upper frame section 110 forming a top tube. The lower frame section 108 extends toward a bottom bracket 106, which includes a pedal shaft 104. A drive device 106, which includes an electric motor, is provided in the area of the bottom bracket 106. Furthermore, the electric bicycle 100 includes a battery 300 for supplying the electric motor with electrical energy. The battery 300 is, for example, also arranged in the down tube 108.

FIG. 2 shows an embodiment of the battery 300 in a cross-sectional view. The view cuts through the housing 306 of the battery 300, and the outline of the housing 306 is shown as a dashed line. The housing 306 is formed, for example, primarily of metal, in particular aluminum. End caps, which are made of plastic, for example, may be attached to the longitudinal ends.

A plurality of battery cells 302 are arranged inside the housing 306. The battery cells 302 are interconnected. The battery cells 302 are, for example, lithium-ion cells.

Furthermore, a portion of a battery management unit 200 is arranged within the housing 306. The battery management unit 200 is positioned at a longitudinal end of the housing 306. A connection point 202 in the form of a female connector protrudes from the housing 306 and is freely accessible from outside the housing 306, for example, to electrically connect the electric motor. The connection point 202 is arranged on a printed circuit board 210 of the battery management unit 200. The battery management unit 200 is electrically connected to the battery cells 302 via a busbar 304.

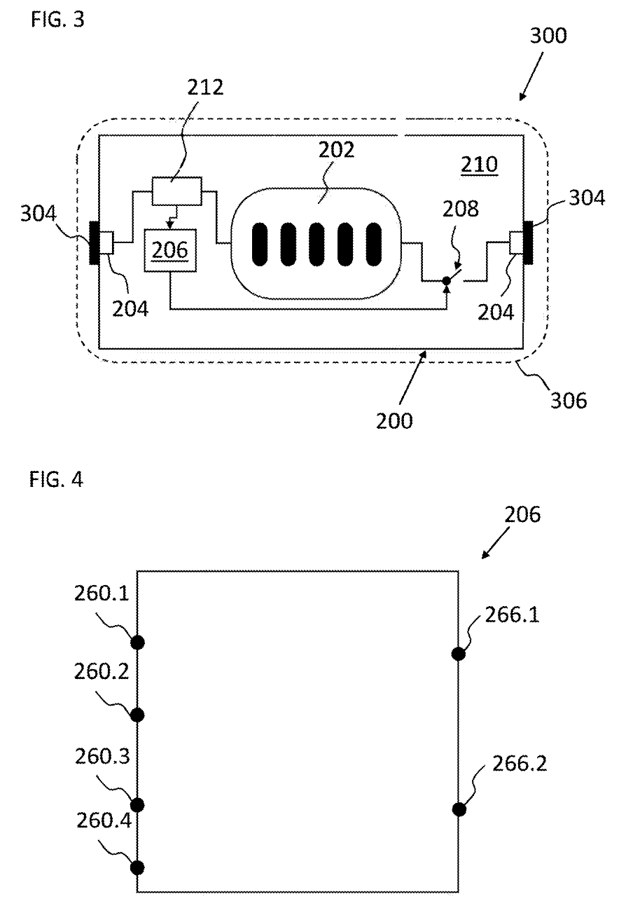

FIG. 3 shows the embodiment of the battery 300 from FIG. 2 as viewed along the longitudinal axis of the housing 306. A top view of the printed circuit board 210 of the battery management unit 200 is shown. The housing 306 is depicted as transparent, with only its outline shown as a dashed line.

The battery management unit 200 includes a connector 202 with a plurality of contacts. Contact points 204 are provided on the printed circuit board 210, which are connected to the busbars 304. A protection circuit is provided on the printed circuit board 210, which is integrated into a chip 206. The chip 206 is, for example, an FPGA, specifically a configurable mixed-signal matrix. The left contact point 204, which forms, for example, a cathode of the battery management unit 200, and the connection point 202 are electrically coupled to one another via a shunt resistor 212. The shunt resistor 212 is signal-technically connected to inputs of the chip 206.

The right contact point 204, which forms, for example, an anode of the battery management unit 200, can be connected to the connection point 202 via an electronic switch 208. The electronic switch 208 is, for example, a MOSFET. The switch 208 is signal-technically connected to an output of the chip 206.

During operation, the battery cells of battery 300 can be discharged, thereby supplying electrical energy to an electrical device that can be connected to connection point 202. The chip 206, or rather the protection circuit integrated therein, receives input signals at its inputs and detects an overcurrent or a short circuit during discharge, generating a corresponding control signal for the switch 208. Opening the switch 208 then interrupts the discharge process, for example.

In addition, the battery cells of battery 300 can be charged via connection point 202. An overcurrent during the charging process or an excessively high voltage in the battery cells is, for example, also detected by the chip 206 or the protection circuit integrated therein, and a corresponding control signal is generated, which opens switch 208 and thereby interrupts the charging process.

FIG. 4 shows the chip 206 in greater detail. It can be seen that the chip 206 has four inputs. Input 260.1 is intended for an input signal representative of a short-circuit current during the discharge of the battery cells. Input 260.2 is intended for an input signal representative of a discharge current during the discharge of the battery cells. Input 260.3 is intended for an input signal representative of a charging current during the charging of the battery cells. Finally, input 260.4 is intended for an input signal representative of a voltage of the battery cells. The chip 206, or rather the protection circuit integrated therein, is configured to compare the respective input signal with a corresponding threshold value and to generate a control signal based on this comparison.

In FIG. 4, the chip 206 includes two outputs 266.1, 266.2. For example, output 266.1 outputs a control signal configured to open an electronic switch during the discharge of the battery cells. For example, output 266.2 outputs a control signal configured to open another electronic switch during the charging of the battery cells

It is understood that the foregoing description is that of the preferred embodiments of the invention and that various changes and modifications may be made thereto without departing from the spirit and scope of the invention as defined in the appended claims.

LIST OF REFERENCES
100 Electric bicycle
102 Bicycle frame
104 Pedal shaft
106 Drive device
108 Down tube
110 Top tube
200 Battery management unit
202 Connection point
204 Contact point
206 Chip with integrated protection circuit
208 Switch
210 Printed circuit board
212 Shunt resistor
260.i Input
266.i Output
300 Battery
302 Battery cell
304 Busbar
306 Housing

What is claimed is:

1. A battery management unit for an electric bicycle, the battery management unit comprising:
a contact point for contacting the battery management unit to a battery cell;
a connection point for connecting an external device to supply the external device with electrical energy from the battery cell;
a protection circuit for protection against at least one of overcurrent and overvoltage;
said protection circuit being configured to cause an interruption of an electrical connection between said contact point and said connection point in an event of at least one of the overcurrent and the overvoltage during operation; and,
said protection circuit being integrated into a chip.

2. The battery management unit of claim 1, wherein said chip is a field-programmable gate array.

3. The battery management unit of claim 1, wherein said protection circuit is a configurable mixed-signal matrix.

4. The battery management unit of claim 1, wherein said protection circuit provides protection against the overcurrent during discharge of the battery cell.

5. The battery management unit of claim 1, wherein said protection circuit includes protection against short circuits.

6. The battery management unit of claim 1, wherein said protection circuit includes protection against the overcurrent during charging of the battery cell.

7. The battery management unit of claim 1, wherein the protection circuit includes protection against the overvoltage during charging of the battery cell.

8. The battery management unit of claim 1 further comprising:
an electronic switch for interrupting the electrical connection between said connection point and said contact point;
said protection circuit including an input for an input signal representative of a discharge current during discharge of the battery cell;
said protection circuit having an output for outputting a control signal for said electronic switch;
said output being electrically connected to said electronic switch; and,
said protection circuit being configured to compare the input signal with a threshold value and to generate the control signal based on the comparison.

9. The battery management unit of claim 8, wherein said protection circuit is configured such that the control signal is generated with a delay following the comparison.

10. The battery management unit of claim 8, wherein said electronic switch is a MOSFET.

11. The battery management unit of claim 8, wherein:
said protection circuit includes a further input for a further input signal representative of:
a short-circuit current during discharge of the battery cell, or
a charging current during the charging of the battery cell, or
a voltage of the battery cell;
said protection circuit is configured to compare the further input signal with a further threshold value and to generate the control signal based on the comparison.

12. A battery for an electric bicycle, the battery comprising:
a battery cell;
a housing;
a battery management unit having a contact point for contacting said battery management unit to said battery cell and a connection point for connecting an external device to supply the external device with electrical energy from said battery cell;
said battery management unit further having a protection circuit for protection against at least one of overcurrent and overvoltage;
said protection circuit being configured to cause an interruption of an electrical connection between said contact point and said connection point in an event of at least one of the overcurrent and the overvoltage during operation;
said protection circuit being integrated into a chip;
said battery management unit being electrically connected to said battery cell;
said battery cell and at least a portion of said battery management unit being arranged within said housing; and,
said connection point being accessible from outside said housing.

13. An electric bicycle comprising:
a battery including a battery cell, a housing, and a battery management unit;
said battery management unit having a contact point for contacting said battery management unit to said battery cell and a connection point for connecting an external device to supply the external device with electrical energy from said battery cell;
said battery management unit further having a protection circuit for protection against at least one of overcurrent and overvoltage;
said protection circuit being configured to cause an interruption of an electrical connection between said contact point and said connection point in an event of at least one of the overcurrent and the overvoltage during operation;
said protection circuit being integrated into a chip;
said battery management unit being electrically connected to said battery cell;
said battery cell and at least a portion of said battery management unit being arranged within said housing;
said connection point being accessible from outside said housing; a drive device with an electric motor for propelling the electric bicycle; and, said drive device being coupled to said connection point to supply said drive device with the electrical energy from said battery.
